(19) United States
(12) Patent Application Publication
(10) Pub. No.: US 2022/0412445 A1
(43) Pub. Date: Dec. 29, 2022

(54) GEAR BACKLASH CONTROL MECHANISM

(71) Applicant: QISDA CORPORATION, Taoyuan City (TW)

(72) Inventor: Chih-Ying Lin, Taoyuan City (TW)

(73) Assignee: QISDA CORPORATION, Taoyuan City (TW)

(21) Appl. No.: 17/482,398

(22) Filed: Sep. 22, 2021

(30) Foreign Application Priority Data
Jun. 25, 2021 (CN) 202110708907.3

(51) Int. Cl. F16H 55/24; F16H 57/022

(52) U.S. Cl. CPC F16H 55/24; F16H 57/022; F16H 2057/0213

(57) ABSTRACT

A gear backlash control mechanism includes a base, a worm gear pivoted to the base, a driving member, a biasing member, a driving worm set having a first shaft, a first worm and a first linkage structure jacketing the first shaft, and a driven worm set having a second shaft, a second worm axially slidable on the second shaft, and a second linkage structure fixed to the second shaft and linked to the first linkage structure. The driving member rotates the worm gear via the first shaft and the first worm and rotates the second worm via the first and second linkage structures and the second shaft. When the worm gear rotates, the first worm abuts against a first tooth surface of each tooth of the worm gear sequentially, and the biasing member pushes the second worm to abut against a second tooth surface of each tooth sequentially.

### BACKGROUND OF THE INVENTION

### 1. Field of the Invention

The present invention relates to a gear backlash mechanism, and more specifically, to a gear backlash control mechanism utilizing a biasing member for backlash elimination.

### 2. Description of the Prior Art

For a precision instrument for continuous horizontal rotation measurement, such as an auto-rotation measurement platform, it usually has a transmission mechanism composed of a worm and a worm gear for driving a vertical rod connected to the worm to rotate relative to a vertical axis by a motor during the measurement process.

However, since there is a gear backlash existing between the worm and the worm gear in the transmission mechanism, an output shaft of the transmission mechanism can still rotate slightly if an external force is exerted upon the output shaft as the motor stops working, so as to cause poor positioning accuracy in rotation angle control. Furthermore, if the precision instrument includes a vibrating member disposed therein, vibration of the output shaft occurs accordingly since the output shaft cannot be positioned fixedly due to the aforesaid gear backlash, so as to cause malfunctioning or measurement failure of the precision instrument. Thus, how to minimize or eliminate the gear backlash in the transmission mechanism is a major issue in the worm gear transmission mechanical design.

### SUMMARY OF THE INVENTION

The present invention provides a gear backlash control mechanism including a base, a worm gear, a driving worm set, a driven worm set, a driving member, and a biasing member. The worm gear is rotatably disposed on the base. A highest point of each tooth of the worm gear is a tooth top, a lowest point of each tooth of the worm gear is a tooth bottom, and a first tooth surface and a second tooth surface are located at two sides of the tooth top of each tooth respectively. The driving worm set is rotatably disposed on the base and has a first shaft, a first worm, and a first linkage structure. The first worm and the first linkage structure jacket the first shaft to rotate synchronously with the first shaft. The first worm is engaged with the worm gear and abuts against the first tooth surface of each tooth of the worm gear sequentially when the first worm drives the worm gear to rotate. The driven worm set is rotatably disposed on the base and has a second shaft, a second worm and a second linkage structure. The second worm is synchronously rotatable and axially sildable relative to the second shaft and is engaging with the worm gear. The second linkage structure fixedly jackets the second shaft and is linked to the first linkage structure to make the second shaft synchronously rotatable with the first shaft. The driving member is connected to the first shaft for rotating the first shaft to drive the worm gear to rotate via the first worm and drive the second worm to rotate via the first linkage structure, the second linkage structure, and the second shaft. The biasing member abuts against the base and the second worm. The biasing member pushes the second worm in an axial direction of the second shaft to abut against the second surface of each tooth of the worm gear sequentially when the worm gear rotates.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a gear backlash control mechanism according to an embodiment of the present invention.

FIG. 2 is an enlarged diagram of a worm gear in FIG. 1.

FIG. 3 is a top view of the gear backlash control mechanism in FIG. 1.

### DETAILED DESCRIPTION

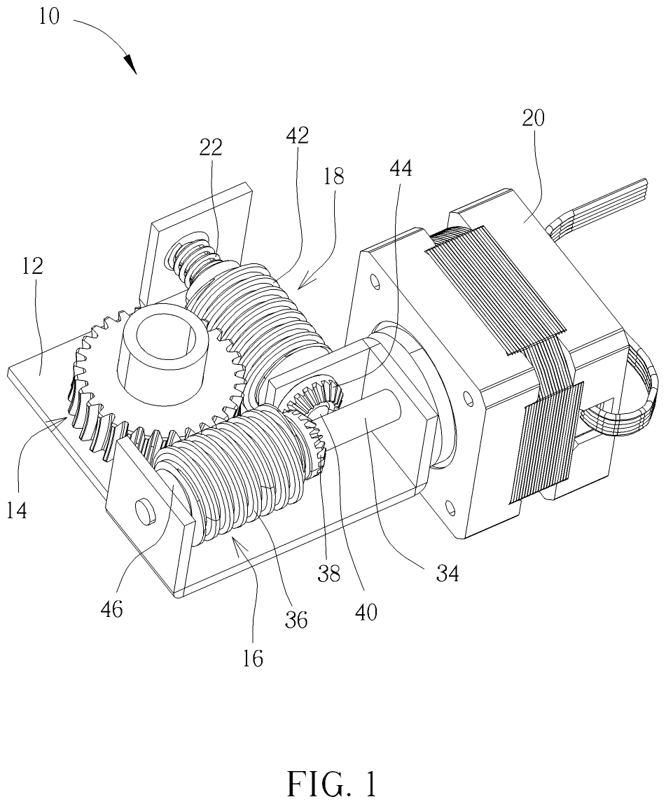

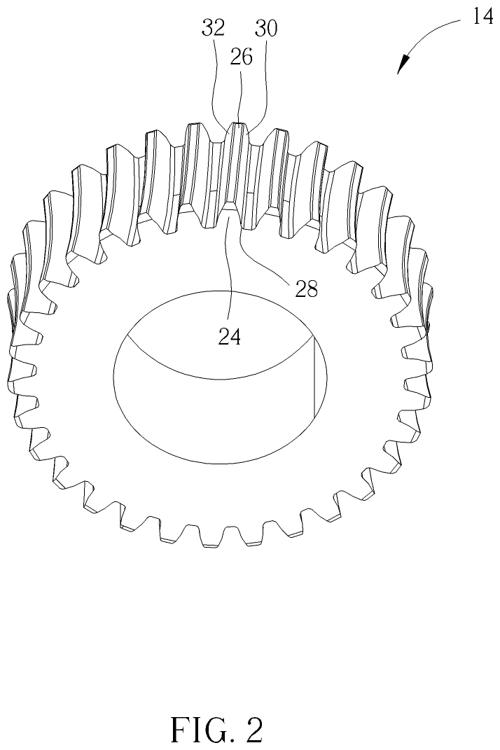

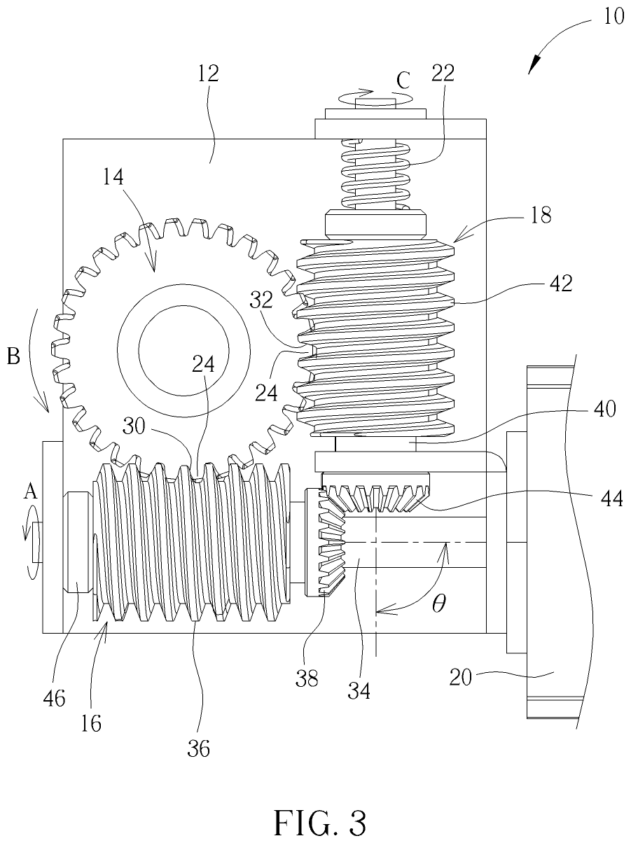

Please refer to FIG. 1, FIG. 2, and FIG. 3. FIG. 1 is a diagram of a gear backlash control mechanism 10 according to an embodiment of the present invention. FIG. 2 is an enlarged diagram of a worm gear 14 in FIG. 1. FIG. 3 is a top view of the gear backlash control mechanism 10 in FIG. 1. The gear backlash control mechanism 10 could be preferably applied to a vertical rod disposed through a worm gear for continuous rotation measurement (but not limited thereto). As shown in FIG. 1, FIG. 2, and FIG. 3, the gear backlash control mechanism 10 includes a base 12, the worm gear 14, a driving worm set 16, a driven worm set 18, a driving member 20, and a biasing member 22. The worm gear 14 is rotatably disposed on the base 12, and an output shaft of the driving worm set 16 could be disposed along a center axis of the worm gear 14. A highest point of each tooth 24 of the worm gear 14 is a tooth top 26, a lowest point of each tooth 24 of the worm gear 14 is a tooth bottom 28, and a first tooth surface 30 and a second tooth surface 32 are located at two sides of the tooth top 26 of each tooth 14 respectively. The driving worm set 16 is rotatably disposed on the base 12 and has a first shaft 34, a first worm 36, and a first linkage structure 38. The first worm 36 and the first linkage structure 38 fixedly jacket the first shaft 34 to be synchronously rotatable with the first shaft 34, and the first worm 36 is engaged with the worm gear 14. The driven worm set 18 is rotatably disposed on the base 12 and has a second shaft 40, a second worm 42, and a second linkage structure 44. The second worm 42 is synchronously rotatable and axially slidable on the second shaft 40 and is engaged with the worm gear 14. The second linkage structure 44 fixedly jackets the second shaft 40 and is linked to the first linkage structure 38, so as to make the second shaft 40 synchronously rotatable with the first shaft 34. An angle θ between the first shaft 34 and the second shaft 40 could be preferably equal to 90°, meaning that the first shaft 34 could be preferably perpendicular to the second shaft 40, but not limited thereto. In another embodiment, the present invention could adopt the design that the angle θ is not equal to 90°, and the angle design could vary with the practical application of the gear backlash control mechanism 10.

To be more specific, in this embodiment, as shown in FIG. 1, the first linkage structure 38 and the second linkage structure 40 could be preferably bevel gears engaged with each other to make the second shaft 40 synchronously rotatable with the first shaft 34. Furthermore, the present invention could adopt a shaft-hole fitting design to make the second worm 42 slidable axially on the second shaft 40. For example, a cross-sectional contour of the second shaft 40 and an inner hole contour of the second worm 42 are in a non-circular shape and fitted with each other, so as to make the second worm 42 rotatable synchronously with the second shaft 40 and movable axially on the second shaft 40.

As shown in FIG. 1, the driving member 20 could be preferably a motor and is connected to the first shaft 34 for driving the first shaft to rotate.

The biasing member 22 could be preferably a compressed coil spring (but not limited thereto), which means the aforesaid coil spring having a longer free length jackets the second shaft 40 and abuts against the base 12 and the second worm 42 respectively in a compressed state for providing a biasing force to the second worm 42, so as to keep the second worm 42 abutting against the second tooth surface 32 of the worm gear 14.

Via the aforesaid designs, as shown in FIG. 1, FIG. 2, and FIG. 3, the first worm 36 can rotate synchronously to drive the worm gear 14 to rotate in a rotating direction B (i.e., a counterclockwise direction as shown in FIG. 3) when the driving member 20 drives the first shaft 34 to rotate in a rotating direction A (i.e., a clockwise direction as viewed from the driving member 20 toward the first worm 36). At the same time, since the first worm 36 fixedly jackets the first shaft 34, the first worm 36 can abut against the first tooth surface 30 of each tooth 24 of the worm gear 14 sequentially with counterclockwise rotation of the worm gear 14 (as shown in FIG. 3). In such a manner, the driving member 20 can drive the worm gear 14 to rotate the aforesaid output shaft in the counterclockwise direction as shown in FIG. 3.

During the aforesaid process, via engagement between the first linkage structure 38 and the second linkage structure 44, the second shaft 40 can rotate in a rotating direction C synchronously with rotation of the first shaft 34, and the biasing member 22 can provide the biasing force for pushing the second worm 42 in an axial direction of the second shaft 40. Accordingly, when the worm gear 14 rotates, the second worm 42 can abut against the second tooth surface 32 of each tooth 24 of the worm gear 14 sequentially (as shown in FIG. 3). In such a manner, if an external force is exerted upon the worm gear 14 for rotating the worm gear 14 in the counterclockwise direction as shown in FIG. 3, the second worm 42 in FIG. 3 can have a tendency to slide upward. In this condition, as long as the external force does not exceed the biasing force provided by the biasing member 22, the second worm 42 can prevent the worm gear 14 from rotating in the counterclockwise direction by abutting against the second tooth surface 32, so as to eliminate the gear backlash of the worm gear 14 in the counterclockwise direction. In summary, via the design that the first worm 36 abuts against the first tooth surface 30 and the second worm 42 abuts against the second tooth surface 42 (as shown in FIG. 3), the gear backlash control mechanism 10 provided by the present invention can generate the zero backlash effect. That is, during continuous rotation of the worm gear 14 in the rotating direction B (i.e., the counterclockwise direction as shown in FIG. 3), each first tooth surface 30 of the worm gear 14 can be pushed sequentially by the first worm 36 in the counterclockwise direction, and each second tooth surface 32 of the worm gear 14 can be pressed sequentially by the second worm 42 in the clockwise direction as shown in FIG. 3, so as to achieve the zero backlash purpose. As such, the present invention can efficiently solve the prior art problem that the gear backlash causes poor positioning accuracy and vibration of the transmission mechanism.

In practical application, the aforesaid axial sliding design could be applied to the first worm. For example, a cross-sectional contour of the first shaft 34 and an inner hole contour of the first worm 36 could be in a non-circular shape (e.g., a hexagonal shape, but not limited thereto) and fitted with each other, so as to make the first worm 36 rotatable synchronously with the first shaft 34 and movable axially on the first shaft 34. Moreover, in this embodiment, as shown in FIG. 1 and FIG. 3, the gear backlash control mechanism 10 could further include a thrust bearing 46. The thrust bearing 46 jackets the first shaft 34 and abuts against the base 12 and the first worm 36. Accordingly, when the first worm 36 drives the worm gear 14 to rotate in the counterclockwise direction, the first worm 36 can slide axially on the first shaft 34 until the first worm 36 abuts against the thrust bearing 46. To be noted, the design that the worm is slidable axially on the shaft and rotatable synchronously with the shaft is not limited to the aforesaid embodiments. That is, the present invention could adopt other axial sliding design. For example, the first worm could jacket the first shaft in a key-slot engagement manner to make the first worm slidable axially on the first shaft and rotatable synchronously with the first shaft. Similarly, the second worm could jacket the second shaft in a key-slot engagement manner to make the second worm slidable axially on the second shaft and rotatable synchronously with the second shaft.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A gear backlash control mechanism comprising:
a base;
a worm gear rotatably disposed on the base, a highest point of each tooth of the worm gear being a tooth top, a lowest point of each tooth of the worm gear being a tooth bottom, a first tooth surface and a second tooth surface being located at two sides of the tooth top of each tooth respectively;
a driving worm set rotatably disposed on the base and having a first shaft, a first worm, and a first linkage structure, the first worm and the first linkage structure jacketing the first shaft to rotate synchronously with the first shaft, the first worm being engaged with the worm gear and abutting against the first tooth surface of each tooth of the worm gear sequentially when the first worm drives the worm gear to rotate;
a driven worm set rotatably disposed on the base and having a second shaft, a second worm and a second linkage structure, the second worm being synchronously rotatable and axially sildable relative to the second shaft and being engaging with the worm gear, the second linkage structure fixedly jacketing the second shaft and being linked to the first linkage structure to make the second shaft synchronously rotatable with the first shaft;
a driving member connected to the first shaft for rotating the first shaft to drive the worm gear to rotate via the first worm and drive the second worm to rotate via the first linkage structure, the second linkage structure, and the second shaft; and
a biasing member abutting against the base and the second worm, the biasing member pushing the second worm in an axial direction of the second shaft to abut against the second surface of each tooth of the worm gear sequentially when the worm gear rotates.

2. The gear backlash control mechanism of claim 1, wherein the biasing member is a spring jacketing the second shaft and abutting against the base and the second worm respectively.

3. The gear backlash control mechanism of claim 1, wherein the first linkage structure and the second linkage structure are bevel gears engaged with each other to make the second shaft synchronously rotatable with the first shaft.

4. The gear backlash control mechanism of claim 1 further comprising:
a thrust bearing jacketing the first shaft and abutting against the base and the first worm respectively to provide an axial supporting force when the first worm pushes the worm gear.

5. The gear backlash control mechanism of claim 1, wherein a cross-sectional contour of the first shaft and an inner hole contour of the first worm are in a non-circular shape and fitted with each other, so as to make the first shaft and the first worm rotatable synchronously and movable axially; a cross-sectional contour of the second shaft and an inner hole contour of the second worm are in a non-circular shape and fitted with each other, so as to make the second shaft and the second worm rotatable synchronously and movable axially.

6. The gear backlash control mechanism of claim 5, wherein the cross-sectional contour of the second shaft and the inner hole contour of the second worm are in a hexagonal shape.

7. The gear backlash control mechanism of claim 1, wherein the first worm jackets the first shaft in a key-slot engagement manner to make the first worm slidable axially and rotatable synchronously relative to the first shaft; the second worm jackets the second shaft in a key-slot engagement manner to make the second worm slidable axially and rotatable synchronously relative to the second shaft.

8. The gear backlash control mechanism of claim 1, wherein the driving member is a motor.

9. The gear backlash control mechanism of claim 1, wherein the first shaft is perpendicular to the second shaft.
